(19) United States
(12) Patent Application Publication
(10) Pub. No.: US 2007/0104177 A1
(43) Pub. Date: May 10, 2007

(54) System and method for allocating bandwidth in a wireless communication system

(75) Inventors: Dong-Oh Hwang, Suwon-si (KR); Min-Hee Cho, Suwon-si (KR); Hee-Kwun Cho, Incheon (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (KR)

(21) Appl. No.: 11/593,297

(22) Filed: Nov. 6, 2006

(30) Foreign Application Priority Data
Nov. 4, 2005 (KR) 105277/2005

(51) Int. Cl. H04B 7/212

(52) U.S. Cl. 370/348; 370/395.21; 455/452.2; 370/320

(57) ABSTRACT

In a method for allocating bandwidth in a wireless communication system, a base station (BS) broadcasts at least one ranging code for which a bandwidth size for bandwidth allocation is set. A mobile station (MS) receives the at least one ranging code, selects a ranging code for which a bandwidth size desired to be allocated from the BS is set, and transmits the selected ranging code to the BS. The BS receives the selected ranging code, allocates a bandwidth corresponding to the received ranging code to the MS, and transmits a message including the bandwidth allocation information to the MS.

### PRIORITY

This application claims the benefit under 35 U.S.C. § 119(a) of an application entitled “System and Method for Allocating Bandwidth in a Wireless Communication System” filed in the Korean Intellectual Property Office on Nov. 4, 2005 and assigned Serial No. 2005-105277, the contents of which are incorporated herein by reference.

### BACKGROUND OF THE INVENTION 1. Field of the Invention

The present invention relates generally to bandwidth allocation in a communication system, and in particular, to a system and method for allocating Uplink (UL) bandwidth in a wireless communication system.

2. Description of the Related Art

The wireless communication system was originally developed to provide voice service and transmit voice data. However, with the rapid growth of technology and ever-increasing user demands, the wireless communication system has evolved to transmit high-speed data. To this end, continuous research and development is actively being performed on the wireless communication system.

FIG. 1 is a diagram illustrating a configuration of a conventional wireless communication system.

Referring to FIG. 1, a wireless communication system generally has a multi-cell configuration including a cell 100 and a cell 150. Further, the wireless communication system includes a first Base Station (BS) 110 for managing the cell 100, a second BS 160 for managing the cell 150, and a plurality of Mobile Stations (MSs) 101, 103, 130, 151 and 153. The BSs 110 and 160 perform data communication with the MSs 101, 103, 130, 151 and 153 through a Uplink (UL) and a Downlink (DL). The MS 130 is located in a boundary area, i.e. handover region, between the cell 100 and the cell 150. That is, if the MS 130 moves toward the cell 150 managed by the second BS 160 while exchanging signals with the first BS 110, a serving BS in communication with the MS 130 is changed from the first BS 110 to the second BS 160.

In the wireless communication system, the link used by the BSs and MSs for communication is generally divided into an uplink and a downlink. The downlink is used for transmitting information from a BS to an MS, and the uplink is used for transmitting information from an MS to a BS.

In order to transmit information to and receive information from a BS, an MS performs a link access procedure with the BS. The MS is allocated a bandwidth from the BS, and then performs communication with the BS.

FIG. 2 is a signaling diagram illustrating uplink bandwidth allocation in a conventional wireless communication system.

Referring to FIG. 2, a BS 200 broadcasts an Uplink Channel Descriptor (UCD) message to MSs in its cell in step 201. The UCD message includes ranging code and ranging channel information.

Upon receipt of the UCD message, an MS 250 selects one of ranging codes for uplink bandwidth allocation, included in the UCD message. The MS 250 sends the selected ranging code over a ranging channel to the BS 200 in step 203.

Upon receipt of the ranging code, the BS 200 sends an Uplink-MAP (UL-MAP) message including a Code Division Multiple Access Allocation Information Element (CDMA Allocation IE) to the MS 250 in step 205. The UL-MAP message has, for example, a 6-byte size. The CDMA Allocation IE transmitted from the BS 200 to the MS 250 is shown in Table 1 below.

TABLE 1

| Syntax | Size | Notes |
|---|---|---|
| CDMA Allocation IE( ) | | |
| { | | |
| Duration | 6 bits | Indicates the duration, in units of |
| | | OFDMA slots, of the allocation |
| Repetition Coding | 2 bits | 0b00-No Repetition |
| Indication | | 0b01-Repetition of 2 used |
| | | 0b10-Repetition of 4 used |
| | | 0b11-Repetition of 6 used |
| Ranging Code | 8 bits | Indicating the CDMA code used by the |
| | | MS |
| Ranging Symbol | 8 bits | Indicating the OFDMA symbol code |
| | | used by the MS |
| Ranging Subchannel | 7 bits | Indicating the OFDMA subchannel |
| | | used by the MS |
| BW Request Mandatory | 1 bit | Indicates whether the SS shall include |
| | | Bandwidth(BW) Request in the |
| | | allocation |
| } | | |

The CDMA Allocation IE includes ‘Duration’ indicating the unit of Orthogonal Frequency Division Multiple Access (OFDMA) slots, ‘Repetition Coding Indication’ indicating the number of repetitions (or iterations), ‘Ranging Code’ indicating a CDMA code used by an MS, ‘Ranging Symbol’ indicating an OFDMA symbol used by the MS, ‘Ranging Subchannel’ indicating an OFDMA subchannel used by the MS, and ‘Bandwidth (BW) Request Mandatory’ indicating whether the MS will request a bandwidth.

Upon receipt of the UL-MAP message, the MS 250 sends a Bandwidth Request Header, which is a message for requesting a bandwidth, to the BS 200 in step 207. The Bandwidth Request Header has, for example, a 6-byte size. The Bandwidth Request Header transmitted the MS 250 to the BS 200 is shown in Table 2 below.

TABLE 2

| Syntax | Size | Notes |
|---|---|---|
| BW-REQ Header( ) | | |
| { | | |
| HT | 1 bit | Header Type = 1 |
| EC | 1 bit | Encryption, always set to zero |
| Type | 3 bits | Indicates the type of Bandwidth Request |
| | | Header |
| BR | 19 bits | Bandwidth Request |
| CID | 16 bits | Connection Identifier |
| HCS | 8 bits | Header Check Sequence |
| } | | |

Bandwidth Request Header includes ‘Header Type (HT)’ indicating a header type, ‘Encryption (EC)’ indicating encryption, which is always set to ‘0′, ‘Type’ indicating a type of Bandwidth Request Header, ‘Bandwidth Request (BR)’ indicating bandwidth request, ‘Connection Identifier (CID)’ indicating a connection ID, and ‘Header Check Sequence (HCS)’ indicating a header check sequence. Therefore, the MS 250 sends a notification indicating a size of its desired uplink bandwidth to the BS 200 through the Bandwidth Request Header.

Upon receipt of the Bandwidth Request Header, the BS 200 sends a UL-MAP message including bandwidth allocation information to the corresponding MS 250 in step 209.

Upon receipt of the allocated uplink bandwidth through the UL-MAP, the MS 250 transmits data to the BS 200 in step 211. Generally, in communication between a BS and an MS, the MS is allocated a bandwidth through the uplink bandwidth allocation, and can communicate with the BS using the allocated bandwidth. For the bandwidth allocation, the MS 250 can communicate with the BS 200 by sending a request for a service bandwidth for data transmission to the BS 200.

The bandwidth request for the initial network access will be described. In this case, an MS conducts negotiation on the basic function of a Mobile Station (MS), and the MS continuously sends an SS Basic Capability-Request (SBC-REQ) message and a Registration Request (REG-REQ) for registering the MS in a BS to the BS. In order to send these messages, the MS undergoes the above bandwidth request process. When the MS makes initial network access with the BS, the MS should undergo the bandwidth request process every time, causing an increase in the time required for initial access.

The wireless communication system, which takes mobility of MSs into account, broadcasts a Mobile Neighbor Advertisement (MOB-NBR-ADV) message including information on neighbor BSs to each of the MSs so that the MSs located in the cell boundary can acquire synchronization with the neighbor BSs without performing initial ranging. Here, the MS acquires synchronization with the neighbor BSs through the MOB-NBR-ADV message, measures signal strengths of the neighbor BSs, and requests uplink bandwidth allocation for handover request if there is any neighbor BS having a signal strength which is higher than that of its serving BS.

In the course of the uplink bandwidth allocation, the MS may not normally receive BS signals. For example, if the BS signal strength is low as the MS is located in the cell boundary, or when the wireless channel condition deteriorates, the MS may fail to normally receive the BS signals.

FIG. 3 is a signaling diagram illustrating uplink bandwidth allocation when a BS fails to receive a UL-MAP message in a conventional wireless communication system.

Referring to FIG. 3, a BS 300 broadcasts a UCD message including ranging code and ranging channel information in step 301.

Upon receipt of the UCD message, an MS 350 selects one of ranging codes for uplink bandwidth allocation, included in the UCD message, and transmits the selected ranging code over a ranging channel to the BS 300 in step 303.

Upon receipt of the ranging code, the BS 300 sends a UL-MAP message including a CDMA Allocation IE in step 305. Herein, it is assumed that the MS 350 fails to normally receive the UL-MAP message transmitted by the BS 300.

Upon failure to receive the UL-MAP message from the BS 300, the MS 350 retransmits the ranging code transmitted in step 303 to the BS 300 after a lapse of a predetermined time in step 307.

Upon receipt of the ranging code, the MS 350 retransmits a UL-MAP message including the CDMA Allocation IE to the BS 300 in step 309.

Upon receipt of the UL-MAP message, the MS 350 sends a Bandwidth Request Header, which is a message for requesting a bandwidth, to the BS 300 in step 311.

Upon receipt of the Bandwidth Request Header, the BS 300 sends a UL-MAP message including bandwidth allocation information to the corresponding MS 350 in step 313.

Upon receipt of the allocated uplink bandwidth through the UL-MAP message, the MS 350 transmits data to the BS 300 in step 315.

In some cases, as described above, the MSs located in the cell boundary or having a poor wireless channel condition may fail to normally receive the information for uplink bandwidth allocation, i.e. the UL-MAP message.

When the MS fails to normally receive the UL-MAP message transmitted from the BS, the MS retransmits the ranging code after a lapse of an exponential random backoff, i.e. predetermined time, causing an increase in the time required for uplink bandwidth allocation.

### SUMMARY OF THE INVENTION

It is, therefore, an object of the present invention to provide an uplink bandwidth allocation system and method for transmitting data without time delay in a wireless communication system.

It is another object of the present invention to provide a system and method for stably performing uplink bandwidth allocation taking into account an MS that fails to normally receive BS signals in a wireless communication system.

According to the present invention, there is provided a method for allocating bandwidth in a wireless communication system, including broadcasting, at least one ranging code which is mapped with a bandwidth size for bandwidth allocation is set, receiving, from a mobile station (MS), a ranging code which is one of the at least one ranging code, allocating a bandwidth corresponding to the received ranging code to the MS and transmitting a message including the bandwidth allocation information to the MS.

According to the present invention, there is provided a method for allocating bandwidth in a wireless communication system, including receiving, from a base station (BS), a broadcast message which includes at least one ranging code mapped with a bandwidth size, selecting a ranging code, for which a bandwidth size desired to be allocated is set, from the received ranging codes, transmitting the selected ranging code to the BS and receiving a message including a bandwidth allocation information from the BS.

According to the present invention, there is provided a system for allocating bandwidth in a wireless communication system, including a BS for broadcasting at least one ranging code for which a bandwidth size is set for bandwidth allocation, receiving one of the ranging codes, allocating a bandwidth corresponding to the received ranging code to an MS and transmitting a message including the bandwidth allocation information to the MS, and the MS for receiving the at least one ranging code, selecting a ranging code for which a bandwidth size desired to be allocated from the BS, transmitting the selected ranging code to the BS and receiving the message including the bandwidth allocation information from the BS thereby receiving a bandwidth allocated from the BS.

According to the present invention, there is provided a system for allocating bandwidth in a wireless communication system, including a BS for broadcasting at least one ranging code for which a bandwidth size is set for bandwidth allocation, receiving a selected one of the at least one ranging codes, allocating a bandwidth corresponding to the received ranging code to an MS and transmitting a message including the bandwidth allocation information to the MS.

According to the present invention, there is provided a system for allocating bandwidth in a wireless communication system, including an MS for receiving from a BS at least one ranging code for which a bandwidth size is set, selecting one of the at least one ranging codes for which a bandwidth size desired to be allocated is set, transmitting the selected bandwidth to the BS and receiving a message including bandwidth allocation information from the BS, thereby receiving a bandwidth allocated from the BS.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a configuration of a conventional wireless communication system;

FIG. 2 is a signaling diagram illustrating uplink bandwidth allocation in a conventional wireless communication system;

FIG. 3 is a signaling diagram schematically illustrating uplink bandwidth allocation when a BS fails to receive a UL-MAP message in a conventional wireless communication system;

FIG. 4 is a signaling diagram illustrating uplink bandwidth allocation in a wireless communication system according to the present invention;

FIG. 5 is a signaling diagram illustrating uplink bandwidth allocation for which dedicated ranging codes for handover are used in a wireless communication system according to the present invention;

FIG. 6 is a flowchart illustrating a BS operation of allocating uplink bandwidths in a wireless communication system according to the present invention; and

FIG. 7 is a flowchart illustrating an MS operation of receiving an allocated uplink bandwidth in a wireless communication system according to the present invention.

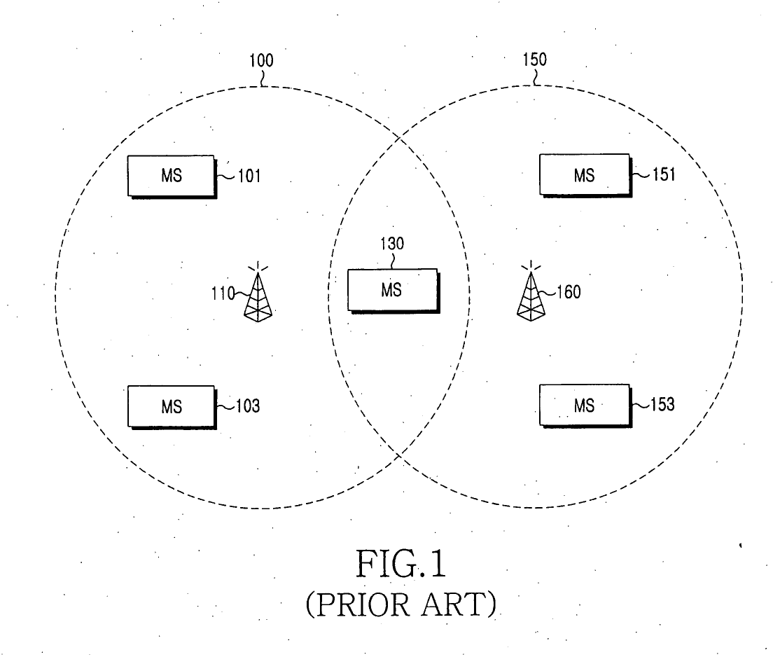

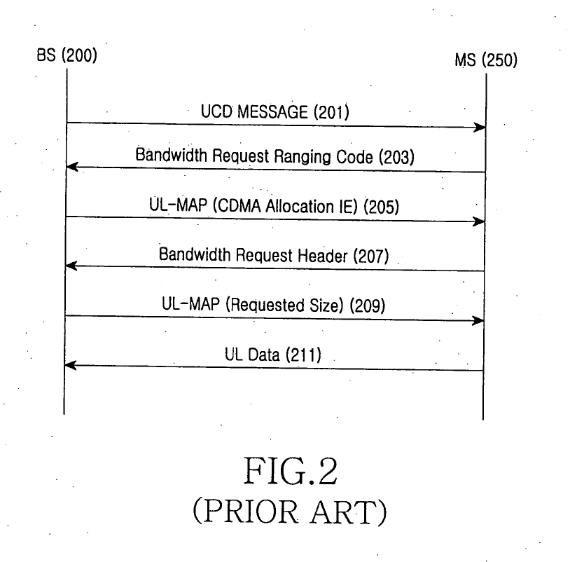

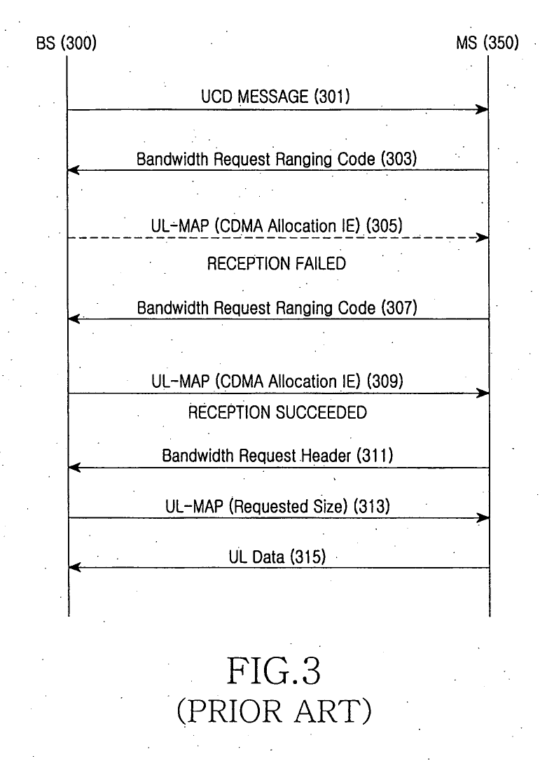

### DETAILED DESCRIPTION OF THE PREFERRED EMBODIMENTS

Preferred embodiments of the present invention will now be described in detail with reference to the annexed drawings. In the following description, a detailed description of known functions and configurations incorporated herein has been omitted for the sake of clarity and conciseness.

The present invention provides a system and method for bandwidth allocation, and in particular, for allocating Uplink (UL) bandwidth in a wireless communication system. According to the present invention, if a BS allocates a bandwidth for at least one ranging code and broadcasts the allocated bandwidth, an MS transmits a ranging code corresponding to its desired bandwidth to the BS, is allocated an uplink bandwidth corresponding to the ranging code from the BS, and communicates with the BS using the allocated bandwidth.

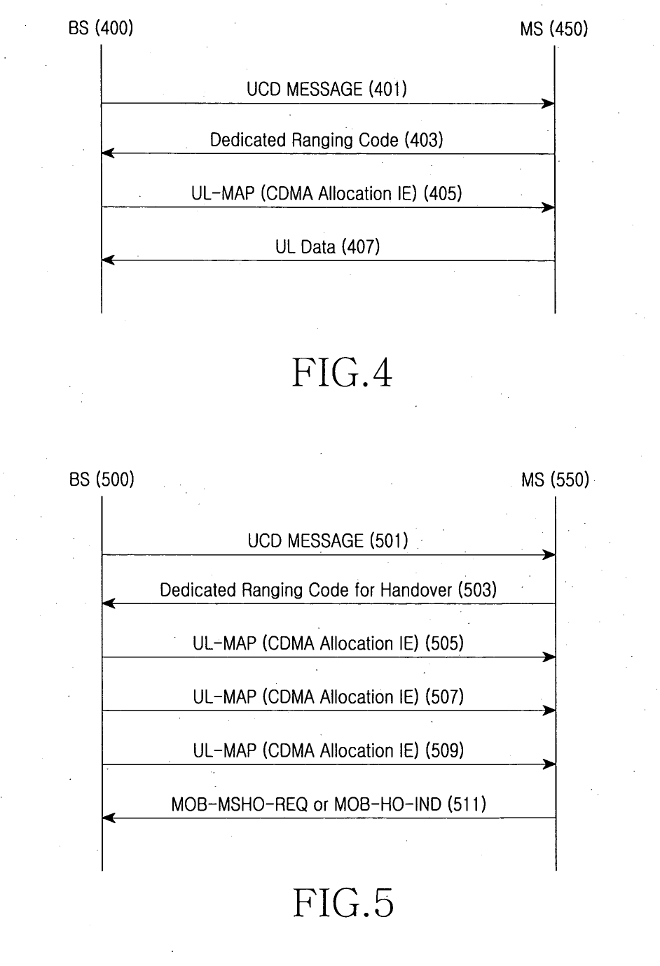

FIG. 4 is a signaling diagram illustrating uplink bandwidth allocation in a wireless communication system according to the present invention.

Referring to FIG. 4, a BS 400 transmits, i.e. broadcasts, a UCD message to an MS 450 in its cell in step 401. In the UCD message, a size of the bandwidth to be allocated to an MS is set according to ranging codes for uplink channel allocation, and a different bandwidth allocation size is set for each ranging code. The UCD message including ranging codes with different bandwidth allocation sizes is shown in Table 3 below.

TABLE 3

| Name | Type(1 Byte) | Length | Value |
|---|---|---|---|
| . . . | | | |
| Initial Ranging Codes | 150 | 1 | Number of |
| | | | initial ranging |
| | | | CDMA codes. |
| Periodic Ranging Codes | 151 | 1 | |
| BW-REQ Ranging | 152 | 1 | |
| Codes | | | |
| HO Ranging Codes | 194 | 1 | |
| Dedicated Ranging | 200 | Variable | |
| Codes | | | |
| Dedicated Ranging | 201 | 1 | |
| Codes for Handover | | | |
| . . . | | | |

The UCD message includes ‘Initial Ranging Codes’ indicating initial ranging Code Division Multiple Access (CDMA) code numbers, ‘Periodic Ranging Code’, ‘Bandwidth-Request (BW-REQ) Ranging Codes’, and ‘Handover (HO) Ranging Code’. In particular, the UCD message includes ‘Dedicated Ranging Codes’, shown in Table 4 below, and ‘Dedicated Ranging Code for Handover’.

TABLE 4

| Syntax | Size | Notes |
|---|---|---|
| Dedicated Ranging Codes( ) | | |
| { | | |
| Number of Dedicated | | |
| Ranging Codes (N_{Dedicated}) | | |
| for (i = 0; i < N_{Dedicated}; i++) | | |
| { | | |
| Number of Codes | 1 | |
| Allocation Size | 1 | In units of Bytes |
| } | | |
| Dedicated Ranging Codes | 1 | |
| for Handover | | |
| } | | |

As shown in Table 4, in the ‘Dedicated Ranging Codes’, a byte-sized bandwidth is allocated for each ranging code. The BS 400 can efficiently perform message transmission for uplink bandwidth allocation by broadcasting the UCD message in which a bandwidth is independently allocated for each individual ranging code. In addition, with the use of ‘Dedicated Ranging Code for Handover’, the BS 400 can broadcast a UL-MAP message a number of times to the MSs that have failed to receive BS signals. The ranging codes transmitted through the UCD message will now be described with reference to Table 5 below.

TABLE 5

| Name | Code Number | Allocation Size (Byte) |
|---|---|---|
| Initial Ranging Codes | 0˜3 | |
| Periodic Ranging Codes | 4˜7 | |
| Bandwidth Ranging Codes | 8˜11 | |
| Handover Ranging Codes | 12˜15 | |
| Dedicated Ranging Codes | 16, 17 | 50 |
| (N_{Ded}1) | | |
| Dedicated Ranging Codes | 18, 19 | 100 |
| (N_{Ded}2) | | |
| Dedicated Ranging Code for | 20, 21 | 50 |
| Handover | | |

Table 5 shows code numbers allocated individually to ranging codes. For example, code numbers 0 to 3 are allocated to initial ranging codes, code numbers 4 to 7 are allocated to periodic ranging codes, code numbers 8 to 11 are allocated to bandwidth ranging codes, code numbers 12 to 15 are allocated to handover ranging codes, code numbers 16 and 17 are allocated to first dedicated ranging codes N_{ded}1, code numbers 18 and 19 are allocated to second dedicated ranging codes N_{ded}2, and code numbers 20 and 21 are allocated to dedicated ranging code for handover.

For example, 50 bytes are allocated to both the first dedicated ranging codes and the dedicated ranging codes for handover, and 100 bytes are allocated to the second dedicated ranging codes. The dedicated ranging codes and the dedicated ranging codes for handover can be additionally extended, and bandwidths can be allocated according thereto.

Therefore, the BS 400 can transmit dedicated ranging codes or dedicated ranging codes for handover to the MSs through the UCD message.

Upon receipt of the UCD message, the MS 450 selects a ranging code corresponding to its required bandwidth, and transmits the dedicated ranging code to the BS 400 in step 403.

Upon receipt of the dedicated ranging code, the BS 400 allocates an uplink bandwidth corresponding to the ranging code to the MS 450, and transmits the uplink bandwidth allocation information to the MS 450 through a UL-MAP message in step 405. The UL-MAP message includes a CDMA Allocation Information Element (CDMA Allocation IE), and also includes bandwidth allocation information in response to an uplink bandwidth request of the MS 450.

Upon receipt of the allocated uplink bandwidth through the UL-MAP message, the MS 450 transmits uplink data to the BS 400 using the allocated uplink bandwidth in step 407. With reference to Table 5 above, a description will now be made of an exemplary operation in which the MS 450 selects the dedicated ranging code, transmits the selected ranging code to the BS 400 and is allocated a bandwidth for the ranging code.

When the MS 450 receives the UCD message, an uplink bandwidth required by the MS 450 for uplink data transmission is assumed to be 100 bytes. Therefore, the MS 450 transmits a ranging code, i.e. dedicated ranging code #18 for which a 100-byte bandwidth is allocated, to the BS 400. Then the BS 400 allocates a 100-byte bandwidth corresponding to the dedicated ranging code to the MS that transmitted the ranging code, and transmits the uplink bandwidth allocation information to the MS 450 through a UL-MAP message, thereby allocating an uplink bandwidth.

FIG. 5 is a signaling diagram illustrating uplink bandwidth allocation for which dedicated ranging codes for handover are used in a wireless communication system according to the present invention.

Referring to FIG. 5, a BS 500 transmits, i.e. broadcasts, a UCD message to an MS 550 in its cell in step 501. In the UCD message, a size of the bandwidth allocated to every ranging code for uplink channel allocation is set, and a different bandwidth size is set for each ranging code. The UCD message includes not only the bandwidth size, but also dedicated ranging codes for which the number of repetitions is also set, i.e. dedicated ranging codes for handover.

If it is determined that the MS 550 receiving the UCD message is located in the cell boundary, the MS 550 selects a dedicated ranging code for handover in order to transmit a MOB-MSHO-REQ message or a MOB-HO-IND message to the BS 500 or a serving BS. The MS 550 transmits the dedicated ranging code for handover, such as code #20 shown in Table 5, to the BS 500 in step 503.

Upon receipt of the dedicated ranging code for handover, the BS 500 transmits a UL-MAP message used for allocating a 50-byte bandwidth allocated to the dedicated ranging code for handover to the MS 550 in step 505.

If the number of repetitions is set for the dedicated ranging code for handover, the BS 500 continuously transmits the UL-MAP message at intervals in steps 507 and 509. For example, in FIG. 5, the number of repetitions is set to 3. Therefore, the BS 500 transmits the same UL-MAP message for bandwidth allocation to the MS 550 three times in steps 505, 507 and 509. As a result, even though the MS 550 fails to receive the UL-MAP message in the cell boundary area, the BS 500 transmits the UL-MAP message a number of times. Therefore, it is possible to prevent the delay in time for uplink bandwidth allocation as the MS 550 fails to receive the signal transmitted by the BS 500. The UL-MAP message includes therein a CDMA Allocation IE, and for example, includes information for 50-byte bandwidth allocation.

Upon receipt of the allocated bandwidth from the BS 500, the MS 550 sends a MOB-MSHO-REQ message or a MOB-HO-IND message for handover request to the BS 500 in step 511.

The ranging codes for handover can also be used by the MSs scheduled to perform handover. In addition, even the MSs that have failed to normally receive BS signals can be allocated uplink bandwidths from the BS using the ranging codes for handover.

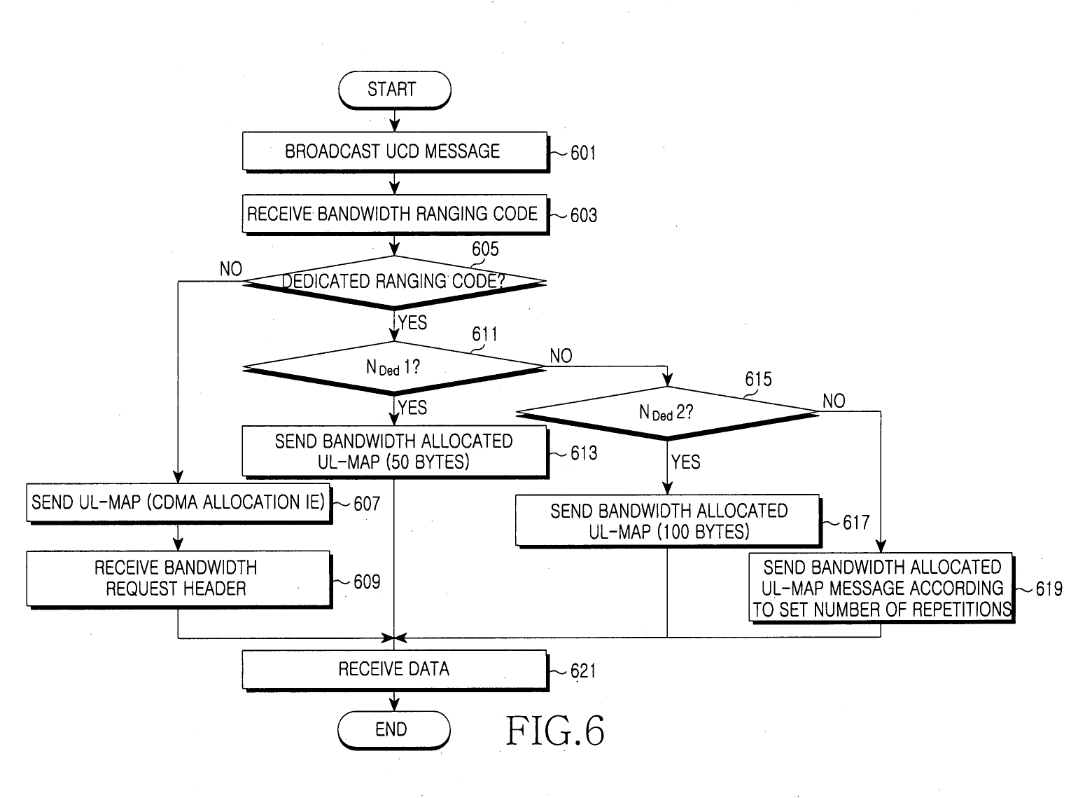

FIG. 6 is a flowchart illustrating a BS operation of allocating uplink bandwidths in a wireless communication system according to the present invention.

Referring to FIG. 6, in step 601, a BS broadcasts a UCD message to MSs in its cell. The broadcasted UCD message includes therein dedicated ranging codes, and for the ranging codes, bandwidths for uplink bandwidth selection required by the MSs in the uplink are set. In addition, the ranging codes include even the ranging codes for handover, i.e. the ranging codes for which not only the bandwidths but also the number of repetitions are set.

In step 603, the BS receives a ranging code from an MS. Here, the bandwidth ranging code received from the MS is the ranging code selected by the MS among the ranging codes included in the UCD message transmitted to the MS by the BS.

In step 605, the BS determines whether the received ranging code is a dedicated ranging code. In other words, the BS determines whether the bandwidth ranging code is a ranging code for which a bandwidth is allocated or the number of repetitions is set. If it is determined that the received ranging code is not the dedicated ranging code, the BS proceeds to step 607, considering that the received ranging code is a bandwidth request ranging code. However, if it is determined that the received ranging code is the dedicated ranging code, the BS proceeds to step 611.

In step 607, the BS transmits a UL-MAP to the MS. Here, the UL-MAP includes a CDMA Allocation IE.

In step 609, the BS receives a Bandwidth Request Header from the MS, and then proceeds to step 621. Upon receipt of the Bandwidth Request Header, the BS allocates a bandwidth to the MS using a UL-MAP.

In step 611, if the received ranging code is the dedicated ranging code, the BS determines whether the ranging code is a first dedicated ranging code. If it is determined that the ranging code is the first dedicated ranging code, the BS allocates in step 613 a bandwidth set for the first dedicated ranging code, for example, the 50-byte bandwidth shown in Table 5, and transmits a UL-MAP including the allocated bandwidth information to the MS, and then proceeds to step 621.

If it is determined that the ranging code is not the first dedicated ranging code, the BS determines in step 615 whether the ranging code is a second dedicated ranging code. If it is determined that the ranging code is the second dedicated ranging code for which a bandwidth is allocated, the BS allocates in step 617 a bandwidth set for the second dedicated ranging code, for example, the 100-byte bandwidth shown in Table 5, and transmits a UL-MAP including the allocated bandwidth information to the MS, and then proceeds to step 621.

If it is determined that the ranging code is not the second dedicated ranging code, indicating that the ranging code is a ranging code for which the number of repetitions is set, then the BS allocates in step 619 a bandwidth allocated for the ranging code, for example, the 50-byte bandwidth shown in Table 5, and continuously transmits the allocated bandwidth information to the MS a number of times, and then proceeds to step 621.

In step 621, the BS receives uplink data from the MS using the allocated bandwidth.

Although the present invention has been described with reference to the case where the dedicated ranging code is divided into first and second dedicated ranging codes, the ranging code can be additionally extended to, for example, the dedicated ranging code for which the number of repetitions is set. As a result, the BS can set various bandwidths for the ranging codes to perform uplink bandwidth allocation, and can also add the number of repetitions, for communication with the MS.

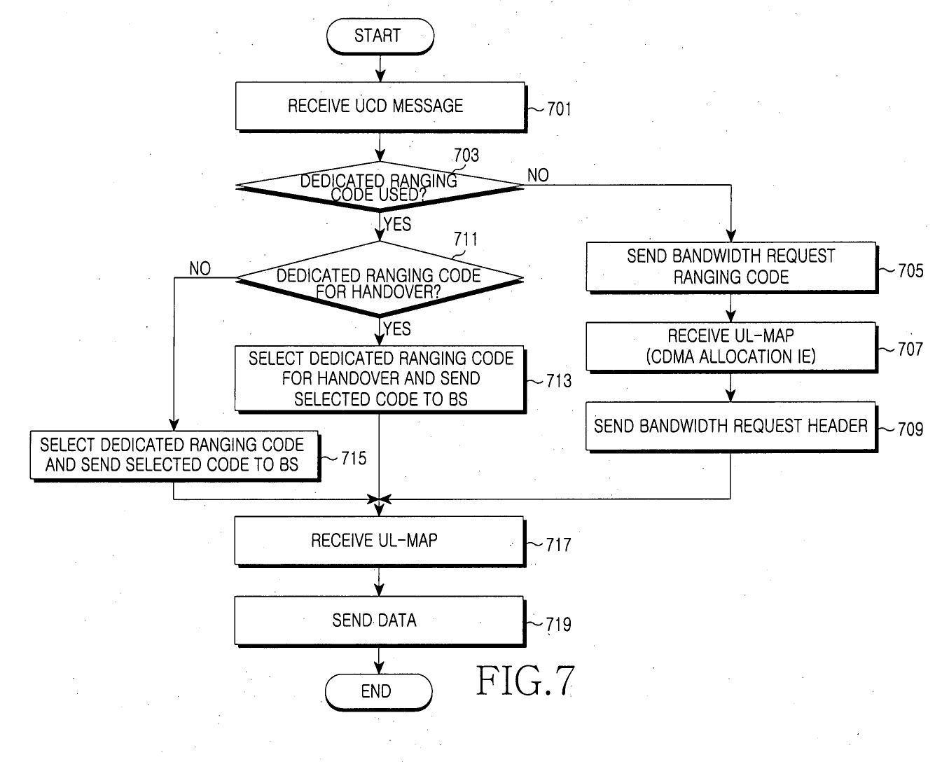

FIG. 7 is a flowchart illustrating an MS operation of receiving an allocated uplink bandwidth in a wireless communication system according to the present invention.

Referring to FIG. 7, in step 701, an MS receives a UCD message from a BS. The UCD message broadcasted from the BS includes dedicated ranging codes, and for the ranging codes, bandwidths required by the MSs in the uplink are set. In addition, the ranging codes include even the ranging codes for handover, i.e. the ranging codes for which not only the bandwidths but also the number of repetitions are set.

In step 703, the MS determines whether to use the dedicated ranging code included in the UCD message received from the BS. If it is determined not to use the dedicated ranging code, the MS proceeds to step 705. However, if it is determined to use the dedicated ranging code, the MS proceeds to step 711.

In step 705, the MS transmits a bandwidth request ranging code to the BS. Here, the MS selects one of the uplink bandwidth request ranging codes, and transmits the selected ranging code over a ranging channel to the BS.

In step 707, the MS receives from the BS a UL-MAP message including a CDMA Allocation IE shown in Table 1.

In step 709, the MS transmits to the BS a Bandwidth Request Header for requesting a bandwidth, and then proceeds to step 717. When the MS does not use the dedicated ranging code, it is allocated an uplink bandwidth from the BS using the conventional uplink bandwidth allocation method.

In step 711, the MS determines whether to perform handover, i.e. whether to use a dedicated ranging code for handover. If it is determined not to use the dedicated ranging code for handover, the MS selects in step 715 a dedicated ranging code according to each bandwidth for uplink data transmission, and then proceeds to step 717. However, if it is determined to use the dedicated ranging code for handover, i.e. if the MS is in a situation where it has difficulty in receiving BS signals, the MS selects in step 713 a dedicated ranging code for handover and transmits the selected ranging code to the BS, and then proceeds to step 717. When the MS selects the dedicated ranging code for handover, it receives from the BS a UL-MAP message for bandwidth allocation a number of times according to the number of repetitions.

In step 717, the MS receives a UL-MAP message including uplink bandwidth allocation information from the BS. In step 719, the MS transmits data to the BS through the uplink bandwidth allocated from the BS. In the case where the MS selects in step 713 the dedicated ranging code for handover and transmits the selected ranging code to the BS, the MS scheduled to perform handover as well as the MSs having low-strength BS signals can select the dedicated ranging code for handover, and continuously receive a UL-MAP message from the BS a number of times according to the number of repetitions.

In sum, the present invention sets uplink bandwidth allocation information for individual ranging codes in the UCD message transmitted by the BS and transmits/receives the ranging codes, making it possible to allocate uplink bandwidths for a short time as compared with the conventional uplink bandwidth allocation method. In addition, the BS continuously transmits the UL-MAP message even to the MSs having the low-strength BS signals a number of times previously set for the ranging code, thereby securing stable uplink bandwidth allocation.

As can be understood from the foregoing description, the BS includes in the UCD message the ranging codes for which bandwidth allocation information is previously set, before transmission. Upon receipt of the UCD message, the MS selects a ranging code and transmits the selected ranging code to the BS, thereby contributing to a decrease in the time required for uplink bandwidth allocation. In addition, the BS continuously transmits the message for uplink bandwidth allocation taking into account the MSs having low-strength BS signals, increasing the reception probability of the message for uplink bandwidth allocation, thereby securing stable uplink bandwidth allocation.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method of a base station (BS) for allocating bandwidth in a wireless communication system, comprising the steps of:
broadcasting at least one ranging code which is mapped with a bandwidth size for bandwidth allocation;
receiving, from a mobile station (MS), a ranging code which is one of the at least one ranging code;
allocating a bandwidth corresponding to the received ranging code to the MS; and
transmitting a message including the bandwidth allocation information to the MS.

2. The method of claim 1, further comprising broadcasting, by a BS, the ranging code for which the bandwidth size along with an Uplink Channel Descriptor (UCD) message.

3. The method of claim 1, further comprising setting a number of repetitions for the ranging code which is mapped with the bandwidth size.

4. The method of claim 3, further comprising the steps of:
receiving, from the MS, a ranging code for which the number of repetitions is set; and
repeatedly transmitting, to the MS, the allocated bandwidth information according to the set number of repetitions.

5. A method of a mobile station (MS) for allocating bandwidth in a wireless communication system, comprising the steps of:
receiving, from a base station (BS), a broadcast message which includes at least one ranging code mapped with a bandwidth size;
selecting a ranging code, for which a bandwidth size desired to be allocated is set, from the received ranging codes;
transmitting the selected ranging code to the BS; and
receiving a message including a bandwidth allocation information from the BS.

6. The method of claim 5, further comprising receiving the broadcast message which includes the at least one ranging code mapped with the bandwidth size through an Uplink Channel Descriptor (UCD) message.

7. The method of claim 5, further comprising receiving the broadcast message which includes the ranging code mapped with the bandwidth size and a number of repetitions.

8. The method of claim 7, further comprising the steps of:
selecting a ranging code for which the number of repetitions is set, if a received signal strength of the MS is lower than predetermined value, transmitting the selected ranging code to the BS; and repeatedly receiving, from the BS, the bandwidth allocation information according to the set number of repetitions.

9. A system for allocating bandwidth in a wireless communication system, comprising:
a base station (BS) for broadcasting at least one ranging code for which a bandwidth size is set for bandwidth allocation, receiving one of the ranging codes, allocating a bandwidth corresponding to the received ranging code to a mobile station (MS), and transmitting a message including the bandwidth allocation information to the MS; and
the MS for receiving the at least one ranging code, selecting a ranging code for which a bandwidth size desired to be allocated from the BS, transmitting the selected ranging code to the BS, and receiving the message including the bandwidth allocation information from the BS thereby receiving a bandwidth allocated from the BS.

10. The system of claim 9, wherein the BS broadcasts the at least one ranging code, for which the bandwidth size is set, to the MS along with an Uplink Channel Descriptor (UCD) message.

11. The system of claim 9, wherein the BS sets a number of repetitions in the at least one ranging code for which the bandwidth size.

12. The system of claim 11, wherein the MS selects one of the at least one ranging codes for which the number of repetitions is set if a received signal strength of the MS is low, transmits the selected ranging code to the BS, and receives the message including the bandwidth allocation information from the BS according to the set number of repetitions.

13. The system of claim 12, wherein upon receiving from the MS the selected ranging code for which the number of repetitions is set, the BS continuously transmits the allocated bandwidth information to the MS according to the set number of repetitions.

14. A system for allocating bandwidth in a wireless communication system, the system, comprising:
a base station (BS) for broadcasting at least one ranging code for which a bandwidth size is set for bandwidth allocation, receiving a selected one of the at least one ranging codes, allocating a bandwidth corresponding to the received ranging code to a mobile station (MS), and transmitting a message including the bandwidth allocation information to the MS.

15. The system of claim 14, wherein the BS broadcasts the at least one ranging code, for which the bandwidth size is set, to the MS along with an Uplink Channel Descriptor (UCD) message.

16. The system of claim 14, wherein the BS sets a number of repetitions in the at least one ranging code for which the bandwidth size.

17. The system of claim 16, wherein upon receipt of the selected ranging code, the BS continuously transmits the allocated bandwidth information to the MS that transmitted the selected ranging code, according to the set number of repetitions.

18. The system of claim 14, wherein the BS includes the bandwidth allocation information in an uplink MAP message.

19. A system for allocating bandwidth in a wireless communication system, the system comprising:
a mobile station (MS) for receiving from a base station (BS) at least one ranging code for which a bandwidth size is set, selecting one of the at least one ranging codes for which a bandwidth size desired to be allocated is set, transmitting the selected bandwidth to the BS, and receiving a message including bandwidth allocation information from the BS, thereby receiving a bandwidth allocated from the BS.

20. The system of claim 19, wherein a number of repetitions is set for the ranging code.

21. The system of claim 19, wherein the MS selects the ranging code for which the number of repetitions is set if a received signal strength of the MS is low, transmits the selected ranging code to the BS, and continuously receives the message including the bandwidth allocation information from the BS according to the set number of repetitions.
